(19) United States
(12) Patent Application Publication
(10) Pub. No.: US 2013/0069449 A1
(43) Pub. Date: Mar. 21, 2013

(54) MODULAR COIL ARRAYS FOR PLANAR AND LINEAR MOTORS

(71) Applicant: Nikon Corporation, Tokyo (JP)

(72) Inventors: Michel Pharand, Los Gatos, CA (US); Michael B. Binnard, Belmont, CA (US); Shigeru Morimoto, Saitama (JP); Chetan Mahadeswaraswamy, San Francisco, CA (US); Rick K. Ingram, Chino Hills, CA (US); Christopher Edward Hatch, San Diego, CA (US); Alex Ka Tim Poon, San Ramon, CA (US); Gaurav Keswani, Fremont, CA (US); Derek Coon, Redwood City, CA (US); Yeong-Jun Choi, San Ramon, CA (US)

(73) Assignee: Nikon Corporation, Tokyo (JP)

(21) Appl. No.: 13/621,669

(22) Filed: Sep. 17, 2012

Related U.S. Application Data
(60) Provisional application No. 61/660,188, filed on Jun. 15, 2012.
(60) Provisional application No. 61/627,049, filed on Sep. 15, 2011.

(51) Int. Cl. H02K 15/06; H02K 41/02

(52) U.S. Cl. 310/12.02

(57) ABSTRACT

Coil arrays are disclosed for a planar or linear motor. An exemplary coil array includes multiple coil modules. Each coil module includes at least one coil set, respective electrical circuitry to and from the coil set, at least one respective hydraulic cooling device for the coil set, and respective hydraulic conduitry to and from the cooling device. The coil modules are interchangeably mountable relative to each other in the array such that mounting the coil module to the array produces accompanying hydraulic and electrical connections between the array and coil module, and removing the coil module from the array severs the connections.

### CROSS-REFERENCE TO RELATED APPLICATIONS

This application claims priority to, and the benefit of, U.S. Provisional Application No. 61/660,188, filed on Jun. 15, 2012, and U.S. Provisional Application No. 61/627,049, filed on Sep. 15, 2011, both of which are incorporated herein by reference in their entirety.

### Field

This disclosure pertains to linear and planar motors, which can be of the moving coil or moving magnet type.

### BACKGROUND

In various precision systems, workpieces and other objects are placed on a stage that is controllably moved and positioned with extremely high accuracy and precision. An example of such a precision system is a microlithography system that produces images on the surfaces of wafers and other lithographic substrates. For high image resolution and accuracy of image placement and registration, the actuators that move and place the stage as required for exposure must be especially suited for this purpose and must be responsive to distance-measurement detectors and sensors such as interferometers or precision encoders. Whereas various actuators have been considered and used in high-precision stages, linear motors and planar motors are particularly advantageous for use in moving stages and the like in microlithography and other high-precision systems. Linear motors and planar motors have a stationary portion (also called a “stator”) and a mover. The mover can be a “moving-magnet” or “moving-coil” type. In either configuration, actuation of the motor causes motion of the mover relative to the stator. In a linear motor the mover moves predominantly in one direction (e.g., in a y-axis direction) when actuated. In a planar motor the mover moves in at least two directions (e.g., in x- and y-directions) when actuated. In a moving-coil planar motor, the stator typically comprises a fixed array of permanent magnets arranged in an x-y plane. In a moving-magnet planar motor, the stator typically comprises a fixed array of electrical coils arranged in an x-y plane. To meet demands posed particularly by latest-generation microlithography systems, linear and planar motors have become extremely complex, especially with the need to prevent them during use from causing problematic temperature increases of the motors themselves and/or of nearby temperature-sensitive components.

Conventional linear and planar motors present the following technical issues with respect to coil arrays: (1) the arrays have become increasingly complex; (2) to meet throughput specifications progressively higher coil densities are required; (3) higher coil densities pose greater challenges with respect to heat removal from the motor, such that integrated cooling of the coils is required; and (4) despite their increasing complexity, there is an acute need for a way to simplify the construction of these motors for better reliability, manufacturability, and serviceability.

### SUMMARY

The need to provide complex coil arrays in planar motors and linear motors is met by embodiments as disclosed herein. One group of embodiments, called “moving magnet” motors, is directed to motors in which the stator is a coil array and the mover is an array of permanent magnets that moves relative to the stator when the motor is energized. Another group, called “moving coil” motors, is directed to motors in which the stator is an array of permanent magnets and the mover is an array of coils that moves relative to the stator when the motor is energized. In many embodiments the problems of establishing and maintaining high coil densities, achieving effective cooling of the coils, and providing efficient use of electronics for driving the coils as well as active-circuit components in linear and planar motors is solved by using multiple layers of electrical coils and hydraulic cooling plates and by tightly integrating the driving and sensing electronics associated with the coils. In both groups of motors, groups of coils are assembled into coil modules that are used in coil assemblies.

Many moving-magnet motors require complex stator-coil arrays. Embodiments as described herein address this requirement by incorporating a coil-modular assembly approach that minimizes electrical cables and hydraulic tubing, and provides smaller, individually testable subassemblies that can be readily integrated into the stator.

A “coil assembly” (also called a “coil array”) comprises multiple coil modules (also called “coil units”) that fit and interconnect with each other in an array of the modules. The coil assembly can be a one-dimensional array (e.g., x or y) of coil modules, as used in a linear motor for example, or a two-dimensional array (e.g., x and y) of coil modules, as used in a planar motor for example. A coil module includes at least one “coil set,” along with respective electronic circuitry at least for driving the coils of the coil set(s), at least one respective cooling device for cooling the coil set(s) using flow of a liquid coolant, and respective hydraulic conduitry connected to the cooling device(s).

A “coil stack” is a group of coils that are conveniently included in a coil module along with associated electronic circuitry, cooling device(s), and hydraulic conduitry for powering and cooling the coils. A coil stack can comprise as few as one individual coil, but usually comprises more than one coil, such as but not limited to three, six, or nine coils as used in a linear or planar motor configured for three-phase operation. The coil stack in many embodiments comprises multiple coil “layers” each comprising one or more individual coils (e.g., three individual coils) having the same orientation. The orientation in many embodiments changes from one layer to the next. Coils arranged in one direction are usually used for operation of the motor principally in one corresponding direction (e.g., x- or y-direction)), and coils arranged in two orthogonal directions are usually used for operation of the motor in at least two directions (e.g., x- and y-directions). In at least a region of the array, the coil modules are interchangeably as well as configurationally mountable relative to each other, wherein mounting a module in the array also (and automatically) achieves both electrical and hydraulic connection of the module to the other modules in the array.

Thus, a coil module comprises at least one “coil set” having one or more (e.g., three or six) electrical coils and multiple cooling devices associated with the coils to remove heat from the coil(s) of the coil set(s). The coil module desirably includes as much of the electrical and hydraulic interconnections as practicable to and from the constituent coils and cooling devices of the module to minimize connections to and from outside the coil module. The coil assembly desirably includes at least one “base” circuit board and at least one “base” coolant manifold configured to receive and hold multiple coil modules of the array (see below).

In an example embodiment, a coil module comprises one coil stack comprising two coil sets each comprising three coils. The coil sets are arranged as superposed respective layers. In a coil stack, respective cooling devices (also called “cooling plates” in this embodiment) are sandwiched between the coil sets as well as situated outside (e.g., above and below) the coil sets. The cooling devices have respective fluid passageways for conducting liquid coolant for removing heat from the coils. These fluid passageways can be or can include microchannels. Cooling devices that circulate coolant liquid for removing heat from the coils are an example of “active cooling” devices, as distinguished from “passive cooling” devices such as a plate made of a thermally conductive material.

A “coil assembly” comprising multiple coil modules includes an interconnection base or frame that desirably includes at least one “base” printed circuit board or the like and at least one “base” coolant manifold. The base is configured to receive multiple coil modules in the desired array thereof. Each coil module attaches to the base in a “plug-in” manner that achieves connection of the electric circuitry and hydraulic conduitry of the module with the circuit board(s) and coolant manifold(s), respectively, of the base. Thus, if a portion of the coil assembly requires service or replacement, the affected coil module can be readily detached for replacement or the like, without having to remove non-affected coil modules from the base. The base can be, for example, a portion of the countermass of the motor.

A coil assembly can be configured with multiple levels of modularity that allow, for example, multiple coil sets to be included in coil modules, multiple coil modules to be included in intermediate coil assemblies, and multiple intermediate coil assemblies to be included in a top-level coil assembly. The modularity (whether on one level or multiple levels) provides benefits including, but not limited to: (a) substantial reduction in the number of electrical interconnect cables from coil to coil and from coils to coil-driver electronics, (b) provision of smaller subassemblies that can be easily removed, replaced or removed, and tested or repaired, (c) substantial reduction in the number of hydraulic interconnection tubes and the like for routing fresh and spent coolant (thereby reducing the probability of coolant leaks and reducing the probability and/or the magnitude of vibration transfer to and from the motor), (d) ease of assembly and testing of the motor, and (e) substantial reduction in the number of electrical cables connected to the coils (thereby reducing the probability of faulty electrical connections and/or vibration transfer to and from the motor). Also, the need to provide high coil density in the modules while also integrating an efficient cooling system is met by embodiments as disclosed herein in which multiple layers of heat-exchanging cooling devices are associated with groups of coils in the modules, along with integrated sensors and other electronics.

The foregoing and additional features and advantages of the invention will be more readily apparent from the following Detailed Description, which proceeds with reference to the accompanying drawings.

### BRIEF DESCRIPTION OF THE DRAWINGS

FIG. 1A is an exploded perspective view of a coil module including one stack of multiple “race-track” flat coils, wherein the coils are arranged as one coil stack comprising two coil sets of three coils each.

FIG. 1B is a schematic depiction of an exemplary manner by which multiple coil modules are mounted to a “base” coolant manifold and “base” PCB.

FIG. 2 is a schematic depiction of the two-tiered aspect of various certain embodiments.

FIG. 3 is a top view of a hex-coil set usable for three-phase operation.

FIG. 4 is a perspective view of three hex-coil sets with respective cooling plates.

FIG. 5 is a perspective view of a linear arrangement of nine hex-coil sets, each comprising three respective coils.

FIG. 6 is a perspective view of a side-by-side array of six hex-coil sets as shown in FIG. 5.

FIG. 7 is a perspective view of an embodiment of a hex-coil module containing a 3×3 matrix of coil sets or a 9×9 matrix of individual coils in each of the x- and y-directions and including microchanneled cooling plates.

FIG. 8 is a perspective view of a planar-motor stator, having a matrix of modular coil modules and configured as a counter-mass for a planar motor.

FIG. 9 is a perspective view of a planar-motor stator, configured as a planar-motor counter-mass and including a coolant manifold to which multiple coil modules are attached.

FIG. 10 is a perspective exploded view of a portion of the embodiment shown in FIG. 9.

FIG. 11 is an exploded isometric view of another embodiment of a coil module.

FIG. 12A is a schematic elevational view of an exemplary cooling plate having a “double cold plate” configuration with parallel coolant flow.

FIG. 12B is a schematic elevational view of an exemplary cooling plate having a “double cold plate” configuration with counter-current coolant flow.

FIG. 13 is a schematic diagram of a microlithographic exposure system, as a representative precision system, including features of the invention described herein.

FIG. 14 is a flow-chart outlining a process for manufacturing a semiconductor device in accordance with the invention.

FIG. 15 is a flow-chart of a portion of a device-manufacturing process in more detail.

### DETAILED DESCRIPTION

The invention is described below in the context of multiple exemplary embodiments, which are not intended to be limiting in any way.

The drawings are intended to illustrate the general manner of construction and are not necessarily to scale. In the detailed description and in the drawings themselves, specific illustrative examples are shown and described herein in detail. It will be understood, however, that the drawings and the detailed description are not intended to limit the invention to the particular forms disclosed, but are merely illustrative and intended to teach one of ordinary skill how to make and/or use the invention claimed herein.

As used in this application and in the claims, the singular forms “a,” “an,” and “the” include the plural forms unless the context clearly dictates otherwise. Additionally, the term “includes” means “comprises.” Further, the term “coupled” encompasses mechanical as well as other practical ways of coupling or linking items together, and does not exclude the presence of intermediate elements between the coupled items.

The described things and methods described herein should not be construed as being limiting in any way. Instead, this disclosure is directed toward all novel and non-obvious features and aspects of the various disclosed embodiments, alone and in various combinations and sub-combinations with one another. The disclosed things and methods are not limited to any specific aspect or feature or combinations thereof, nor do the disclosed things and methods require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and method. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

In the following description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

This disclosure is directed to, inter alia, coil modules configured and serving as repeatable units in a coil array or matrix for a linear or planar motor. A coil module represents a scaled subdivision of the coil array, and includes at least one set of coils.

The coil module also includes cooling devices for the coil set(s), hydraulic connections to and from the cooling devices, and electrical connections to and from the coils, thereby enabling the module to be attached and removed from the array without disturbing or otherwise affecting any of the other modules in the array. The coil module desirably is configured to require a minimal number of hydraulic and electrical connections with other coil modules in the array. To such end the coil module itself includes as many as practicable of the hydraulic and electrical connections, located between the respective coils and cooling devices of the module. In many embodiments the coil module can be inserted substantially anywhere in the array (or at least in a designated portion of the array) and function as if it had been inserted anywhere else in the array. Thus, a coil module can be removed for service or replacement, then replaced with a new one or with a serviced one (or simply with another one), without disturbing other coil modules in the array. Also, the array of coil modules can provide a high density of coils, cooling devices, electronic circuitry, and hydraulic conduitry as required for high-resolution linear and planar motors currently required in certain precision systems.

There is no restriction on the number of coils in a coil module; the number is usually greater than one and less than the total number of coils in the array. By way of example, a module has 2×2 coils (two sets of two coils each), 3×3 coils, 4×4 coils, etc. The coils can be at a single dimensional orientation (for operation principally in one dimension) or at multiple dimensional orientations (e.g., two dimensions, for operation principally in corresponding multiple dimensions). The number of coils need not be identical in each direction. The coils also need not have the same geometrical configuration or thickness. Since the coils in a module are usually configured as one or more coil stacks, thicker coils may be used for producing motion in a first direction, and thinner coils may be used for producing motion in a second direction, especially if the magnetic fields established between magnets and coils of the motor are weaker in the first direction compared to the second direction.

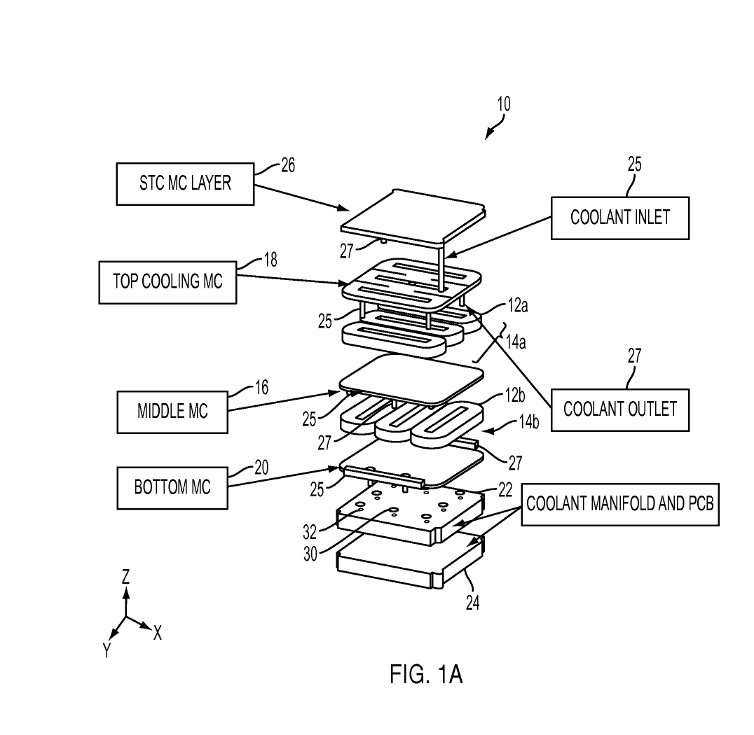

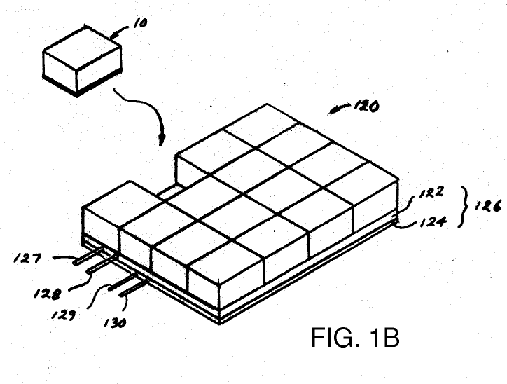

A first embodiment of a coil module 10 is shown in FIG. 1A. The coil module 10 comprises two coil sets 12a, 12b of three coils 14a, 14b each (for 3-phase operation). Each coil has a “racetrack” configuration, so-named because of the shape of its plan profile. The coils 14a in one coil set 12a are at right angles to the coils 14b in the second coil set 12b (for operation in the x- and y-directions). Thus, one coil set 12a is an “x” coil set, and the other coil set 12b is a “y” coil set. Associated with the coil sets 12a, 12b are cooling devices, which in this embodiment are respective heat-exchangers configured as respective microchannel cooling plates 16, 18, 20 that conduct flow of liquid coolant for removing heat from structures adjacent the plates. In this embodiment, sandwiched between the coil sets 12a, 12b is a middle microchannel cooling plate (“middle MC”) 16 that conducts a liquid coolant mainly used for cooling the coils 14a, 14b. Superposed on the “x” coil set 12a is a top-cooling microchannel cooling plate 18 (“top-cooling MC”), and situated beneath the “y” coil set 12b is a bottom-cooling microchannel cooling plate 20 (“bottom MC”). The resulting arrangement of superposed coils and cooling devices is called a “coil stack.”

In a coil module 10, the coil stack(s) is superposed on a coolant manifold 22. The coolant manifold 22 is superposed on a printed circuit board (“PCB”) 24. As shown in FIG. 18, the coil module 10 is incorporated into a module array 120 (or portion of an array). The array 120 includes a “base” coolant manifold 122 and “base” PCB 124 that collectively provide a “base” 126 on which multiple coil modules 10 can be mounted to form the array 120. The manifold 122 and PCB 124 can be respective single units that serve all the coil modules of the motor; alternatively, the manifold 122 and PCB can be divided to serve respective coil modules of multiple zones, for example, serving different coolant needs of different regions.

In many embodiments the manifold 122 and PCB 124 together define respective portions of a base 126 on which multiple coil modules 10 can be mounted to form the array 120. The manifold 122 and PCB 124 collectively provide substantial stiffness to the base 126. If the base includes other structure, such as the countermass of the motor, the manifold 122 and PCB can contribute substantially to the stiffness of the base. When attached to the base 126, the coil modules are integrated with each other to minimize electrical and hydraulic connections within coil modules, from one coil module to the next coil module, and between the array 120 and other locations in the system in which the motor is used. For example, the base manifold 122 configured for one coolant includes a coolant inlet 127 and coolant outlet 128, and the PCB 24 includes first and second electrical connections 129, 130, respectively. The PCBs 124 provide electrical circuitry for routing electrical current to and from the modules for energizing the respective coils in the modules. Thus, the PCB 124 serves multiple coil modules 10. The PCBs 24, 124 can also include and supply power to sensors and the like, such as temperature sensors, etc., associated with the module, as discussed below. If desired, the PCBs 24 can also accommodate signal-processing and/or signal-conditioning circuitry (e.g., for processing data coming from the sensors) as well as processor circuitry.

The coolant manifold 122 provides distribution conduitry for supplying fresh coolant to, and for removing spent coolant from, the microchannel plates in the modules 10, preferably using as few hydraulic interconnections as possible. As noted, the base PCB 124 and coolant manifold 122 provide a “base” 126 to which multiple coil modules 10 can be attached in a “plug-in” manner, wherein attachment of a coil module to the base not only achieves mounting of the coil module to the base but also achieves electrical and hydraulic connections to and from the coil module 10 and from the coil module to other modules already attached to the base. By way of example, the base can be, or be located on, a motor countermass.

The coolant manifold 122 need not be identical over its entire surface. For example, the countermass may have multiple cooling “zones” in which the respective cooling demands are different. Each zone may have a distinctive respective flow-rate of coolant, which may be different from zone to zone. The coolant flow rate through each zone can be independently controlled. Multiple zones can allow for a more efficient delivery of coolant to the modules. Also, the coolant manifold 122 may have multiple portions dedicated to cooling a different respective coolant. For example, the STCs may utilize a different coolant than the cooling plates associated with the coils (the STCs can be cooled with Fluorinert® and the cooling plates associated with the coils can be cooled with water). To provide adequate thermal control, the Fluorinert can be routed to a respective coolant manifold that is separate from the coolant manifold used for cooling water. In a countermass, the Fluorinert coolant manifold can be placed below the coolant manifold for water, wherein each manifold is independently controlled. If the Fluorinert manifold is located below the water manifold, Fluorinert can be fed up through the water manifold into the coil modules. This configuration, in which the manifolds for water and Fluorinert are arranged as respective “layers,” provide maximal compactness.

Thus, the coil array comprises a matrix of coil modules mounted on at least one base manifold. The manifold(s) handle coolant delivery to each coil module, delivering coolant to coolant plates associated with the coils as well as to the STCs. To reduce pitching moments caused by offsets in the center of gravity between, for example, the wafer stage and motor countermass (on which the coil array and base(s) are mounted, the manifold(s) desirably is made of a high-density metal such as but not limited to stainless steel, brass, or tungsten. The closer the center of gravity to the surface of the countermass, the smaller the pitching moment. Desirably, the manifold(s) is mounted to a frame or the like that is also made of a high-density material. To handle a large number of electrical connections, several PCBs can be mounted between the coil modules and the base. Each PCB can handle multiple coil modules and simplifies assembly of the countermass.

Further with respect to the embodiment of FIG. 1A, superposed on the top-cooling MC is a surface-temperature-control (“STC”) layer or plate 26, which desirably is microchanneled or otherwise provided with hydraulic conduitry. The STC layer is discussed below. Each hydraulic plate 16, 18, 20, 26 has at least one respective coolant inlet 25 and at least one respective coolant outlet 27 that delivers fresh coolant and removes spent coolant, respectively, from the plate. The inlets and outlets 25, 27 have sufficient length in the vertical direction to facilitate their hydraulic connections to respective ports 30 in the coolant manifold 22. Thus, on the coolant manifold 22, the ports 30 are arranged relative to each other in a specific way in 3-D space so as to allow making respective connections to the inlets and outlets 25, 27. This pattern is repeated on the coolant manifold 22 to allow freedom of placement of coil modules 10 at any of various locations in the array. The connections of inlets 25 and outlets 27 to respective ports 30 are, in this embodiment, sealed from the external environment using appropriate face-seals 32, such as but not limited to O-rings. In alternative configurations, other sealing means are used. The coil sets 12a, 12b, the cooling plates 16, 18, 20, 26, the coolant manifold 22, and the PCB 24 are stacked in this embodiment with substantially no voids in between, thereby forming a compact and space-efficient coil module 10. The coolant passing through the microchannels 16, 18, 20 and STC 26 need not be the same. For example, in certain embodiments the STC 26 may utilize a different coolant (e.g., Fluorinert®) than the cooling plates 16, 18, 20 (e.g., water). In embodiments in which multiple coolants are used, the coolant manifold 122 can be provided with conduitry sufficient to distribute the coolant(s) to respective destinations in and to collect spent coolant from the coil module.

If desired or required, the coil module 10 can include one or more magnetic-field sensors and/or one or more temperature sensors (not shown). An advantageous location of these sensors is on the module PCB 24. The magnetic-field sensors (e.g., Hall-effect sensors) are used during stage initialization, for example. (A Hall-effect sensor can sense a local magnetic field.) The temperature sensors can be used for monitoring the temperature of the coils at various locations to ensure that none of the coils has a temperature exceeding an established upper temperature limit, which might indicate a cooling or other problem. Respective signals output from the sensors can be sent to, for example, on-board multiplexer circuits and/or other signal-conditioning circuits integrated with the coil module 10. Thus, for example, the printed circuit board 24 can also include one or more multiplexer circuits.

The cooling plates 16, 18, 20 are used for cooling the coil sets 12a, 12b by providing appropriate flow of liquid coolant through fluid passageways (e.g., microchannels) in the plates. Microchannels tend to have thin-walled fluid passageways to ensure efficient heat transfer to and from them. As a result, the cooling plates 16, 18, 20 effectively remove substantially all the heat generated by the coils 14a, 14b as the coils are being electrically energized.

The STC plate 26, also called an “isolation surface” and a “STC layer,” desirably is also microchanneled. “STC” denotes “surface temperature control.” The STC plate is situated and configured to capture residual heat that may have escaped capture by the other cooling plates 16, 18, 20, particularly the top cooling plate 18. Thus, the upper surface temperature of the STC plate 26 (facing away from the coil set) can be maintained at a substantially constant temperature (e.g., room temperature or 22° C.) during operation of the coils. The STC plate 26 also blocks transfer of heat from the coils to nearby structure such as the wafer stage. Thus, the STC plate 26 can be used to block heat from the coils and/or to keep the top surface of the coil module at a substantially uniform temperature.

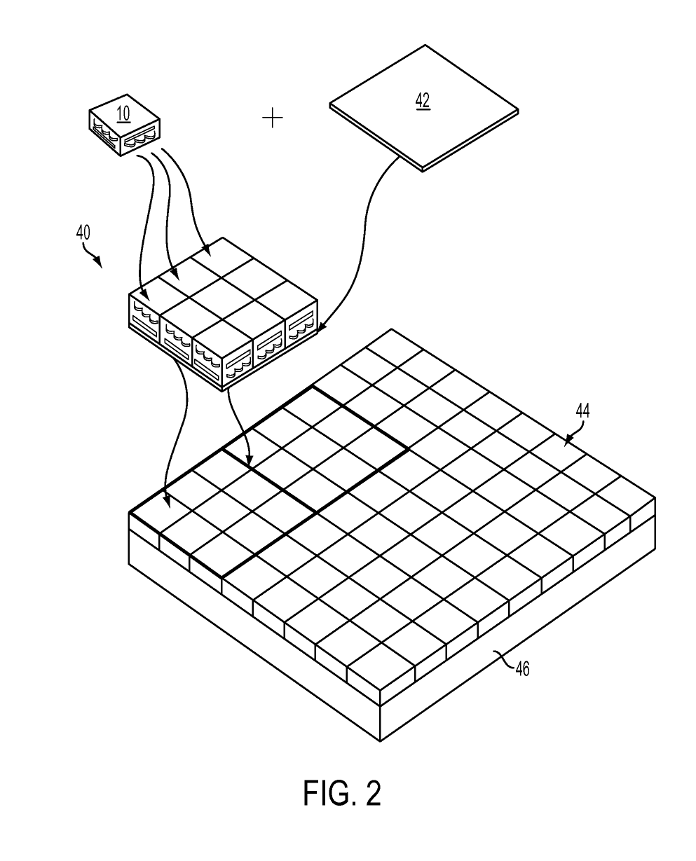

Reference is now made to FIG. 2, schematically depicting one exemplary manner in which a coil module 10 is incorporated as a module into a first-level (or intermediate level) array 40 of multiple coil modules. The coil modules 10 in the first-level array 40 are mounted on a printed circuit board (PCB) 42, which comprises electronic circuitry supplying electrical power to the multiple coil modules. Multiple first-level arrays 40 are incorporated into a second-level (top-level) array 44, of which each first-level array is a coil module. The second-level array 44 in this embodiment is situated on a “base” coolant manifold 46. The base coolant manifold 46 provides hydraulic connections to the inlets and outlets of the microchanneled plates of the coil modules 10 to a source of fresh coolant and a destination for spent coolant, respectively.

In the modules shown in FIGS. 1A and 2, cooling plates are placed where cooling (and hence flow of coolant) is desired in the module. In the depicted coil stack, a middle cooling plate 16 is placed between the x and y coils 14a, 14b, and cooling plates 18 and 20 are placed outside the coil set, which in the depiction is above the x coils 14a and below the y coils 14b, respectively. The cooling plates 16, 18, 20 normally are configured to remove substantially all the heat generated by the coils 14a, 14b during times of coil energization. Any interstitial gaps created by overlaying the x and y coils can be used over multiple layers for passing coolant-supply tubes.

Coolant flow to the coolant plates of a module can be controlled using solenoid-actuated valves having respective flow rates that are controlled using pulse-height and/or pulse-width modulation, for example. Coolant flow to the STC plate 26 can be controlled in a similar manner.

Therefore, a “coil stack” in a coil module comprises at least one (usually at least two) coil sets along with respective cooling devices. In the coil stack, the coil sets are usually situated superposedly to each other, and the coil sets are usually superposed on the coolant manifold and PCB of the module. A coil set can comprise as few as one coil, but usually has multiple coils, such as three, six, or nine coils. These numbers are not intended to be limiting. However, increasing the number of coil stacks and/or coil sets per stack can reduce the desired modular aspect of the assembly, which can result in undesired higher manufacturing and usage costs. On the other hand, reducing the number of coil stacks per module generally requires a greater number of coil modules to form the array, which can also result in high manufacturing and usage costs. The ideal number of coil stacks for a particular usage application will often be a compromise of these competing factors.

Desirably, for satisfactory heat control of the motor, cooling devices are located between the coil sets (if the module has a coil stack including at least two coil sets) as well as above and below the coil sets. The coil stack is not limited to three cooling devices for two coil sets. In some alternative embodiments the cooling device situated between the coil sets can be omitted, especially if cooling demands are less stringent. In other embodiments, especially if cooling requirements are stricter or more difficult to satisfy, the middle MC plate can be configured as multiple superposed cooling plates, e.g., one for principally removing heat generated by the lower coil set and the other for principally removing heat generated by the upper coil set.

Therefore, a “coil module” is an interchangeable unit comprising at least one coil stack, at least one cooling device, a coolant manifold connected to and serving the cooling devices of the module, and an electrical PCB connected to and serving the coils of the module. The coil module is configured to be connected hydraulically and electrically to a “base” coolant manifold and “base” PCB to which multiple other coil modules are connectable, thereby contributing to the formation of coil modules. Connected to the coolant manifold of the module are the cooling devices of the module. Desirably, the hydraulic interconnections are made in the module such that the coil module has a minimal number of hydraulic connections to and from it. (E.g., if two coolants are used, then the module ideally has a minimum of two inlets and two outlets.) Connected to the PCB of the coil module are, as required, coil drivers, sensors (e.g., Hall sensors, thermosensors), ADCs, DACs, sensor-signal processors, logic processors, and any other desired electrical components of the module (space permitting and according to need). The electrical and hydraulic connections to and from the coil module and base are desirably configured to minimize the number of these connections. The desirability of minimizing electronic connections to and from the module is a key reason for placing as much as practicable of the required circuitry and active circuit components on the PCB of the module. The connections for power and signals in and out of the coil module can be (and desirably are) made using a single connector.

The coil modules in a particular array need not be 100% interchangeable with each other, depending upon the particular application, but 100% interchangeability is advantageous for some applications. In addition, the coils in the coil stacks can be any of various configurations, such as but not limited to race-track coils and hex coils. In addition, the array of coil modules as mounted to the “base” manifold is not limited to arrays in which all the coil modules are identical; some arrays can be configured having different respective zones of different coil modules. Hence, in a particular array, the constituent coil modules need not all be identical. For example, the constituent coil modules can be configured according to one or more “families” of different coil modules, and/or the array of coil modules can include modules selected from multiple “groups” of different coil modules. Hence, important aspects of the subject coil modules include their interchangeability (at least to a limited extent) and variable configurability.

Also, the coils in a coil set need not all be identical in configuration (e.g., hex or race-track), and the coil modules in an array are not limited to those having coils all configured the same way.

The array of coil modules on a “base manifold” and “base PCB” can be uniform or variable. For example, in the array the coil modules arranged relative to the x-axis can be of a first configurational type, and the coil modules arranged relative to the y-axis can be of a second configurational type. The array itself can include coil modules all having the same arrangement in a first axial direction and having a different arrangement in a second axial direction. By way of example and not intending to be limiting in any way, a coil array can comprise 42 coil modules (a 6×7 array), wherein the array includes four “zones” of respective groups of modules, wherein the modules in each zone are configured to achieve a particular respective level of temperature control. The cooling devices desirably are configured as defining sealed conduits and/or channels for conducting liquid coolant. Further desirably, the channels are configured as microchannels, which are channels of which at least one orthogonal width or height dimension is 100 μm or less. Cooling devices that are substantially planar, that contact a coil set, and that that include microchannels are termed “microchannel plates” (abbreviated “MC”). In addition, the STC plate, if used, can also include microchannels. The MCs and STC are hydraulically connected as required to achieve efficient cooling, wherein most of the interconnections are made in the coolant manifold of the coil module. Ultimately, the conduitry of the coil modules and of the “base” manifold includes the conduits to and from the coil modules, the conduits to and from the STC, and the conduits between coil modules of the array. Microchannel plates and STCs can be made of any of various rigid, inert, and non-magnetic materials such as, but not limited to, titanium, stainless steel, or ceramic. One or multiple coolants can be used, e.g., water for cooling the coils, and Fluorinert for cooling the STC.

Depending upon the type of motor, the coil arrays can be mounted on the mover (if the motor is a moving-coil type) or on the stator (if the motor is a moving-magnet type). The coil array can be mounted on the countermass of the motor, wherein the countermass can serve as a housing for the array of coil modules.

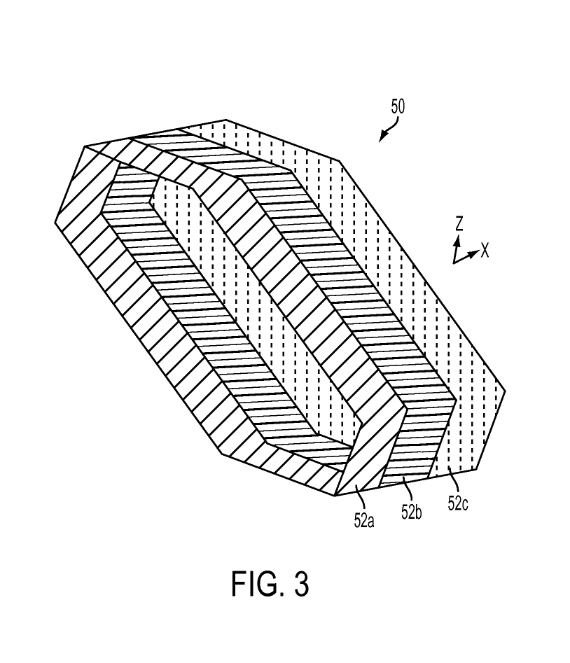

The embodiment of FIGS. 1A and 2 has “race-track” coils. Alternatively, “hex” coils can be used. An example set 50 of three hex coils 52a, 52b, 52c is shown in FIG. 3. A hex coil is largely flattened in the z-direction (but not completely, in that it has a small thickness in the z-dimension). Each coil is also partially displaced in the x- or y-direction so as to be largely non-overlapping with itself.

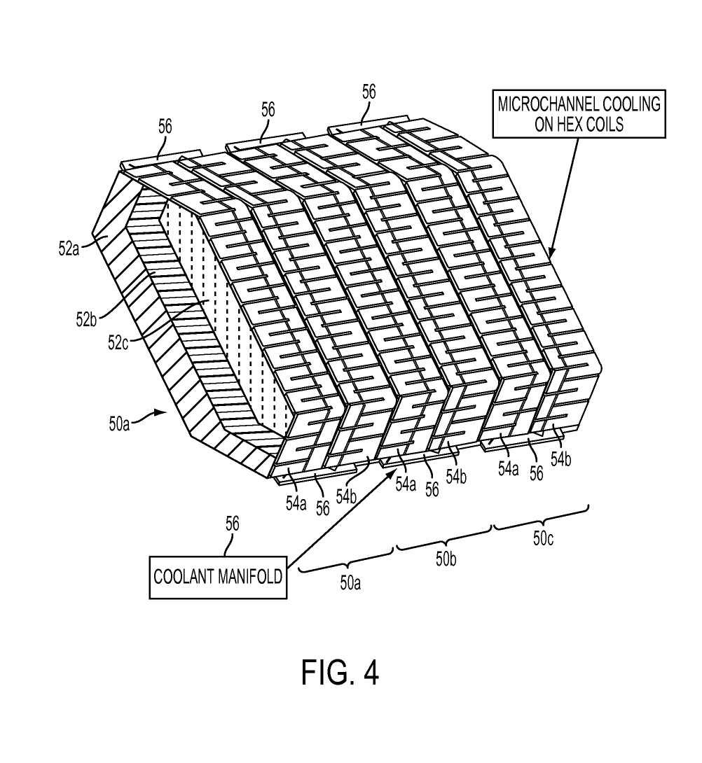

FIG. 4 depicts three coil sets 50a, 50b, 50c each comprising three hex coils 52a, 52b, 52c. The hex coils 52a, 52b, 52c are configured as shown in FIG. 3 and placed side-by-side (only one coil set 50a is visible at left). Each coil set 50a-52c has two associated outer microchannels 54a-54b through which liquid coolant flows. (I.e., two microchannels cool three coils.) The microchannels 54a-54b are connected together hydraulically by coolant manifolds 56.

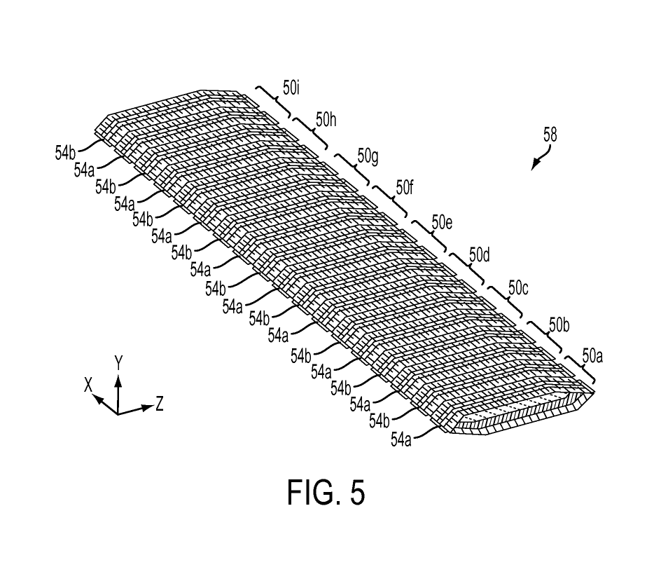

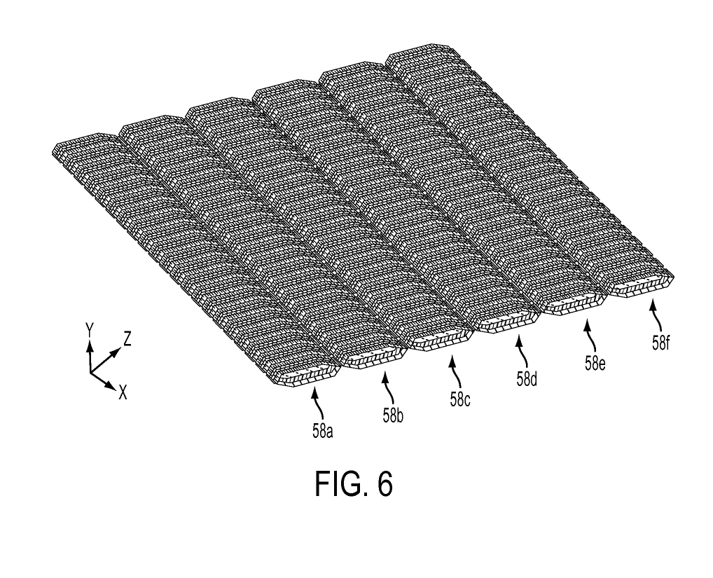

FIG. 5 shows a linear arrangement 58 of nine coil sets 50a-50i. Each coil set is cooled by a respective pair of cooling plates. FIG. 6 shows six linear arrangements 58a-58f placed side-by-side. In each of FIGS. 4, 5, and 6, the coils are arranged for motion in only one direction (x- or y-direction).

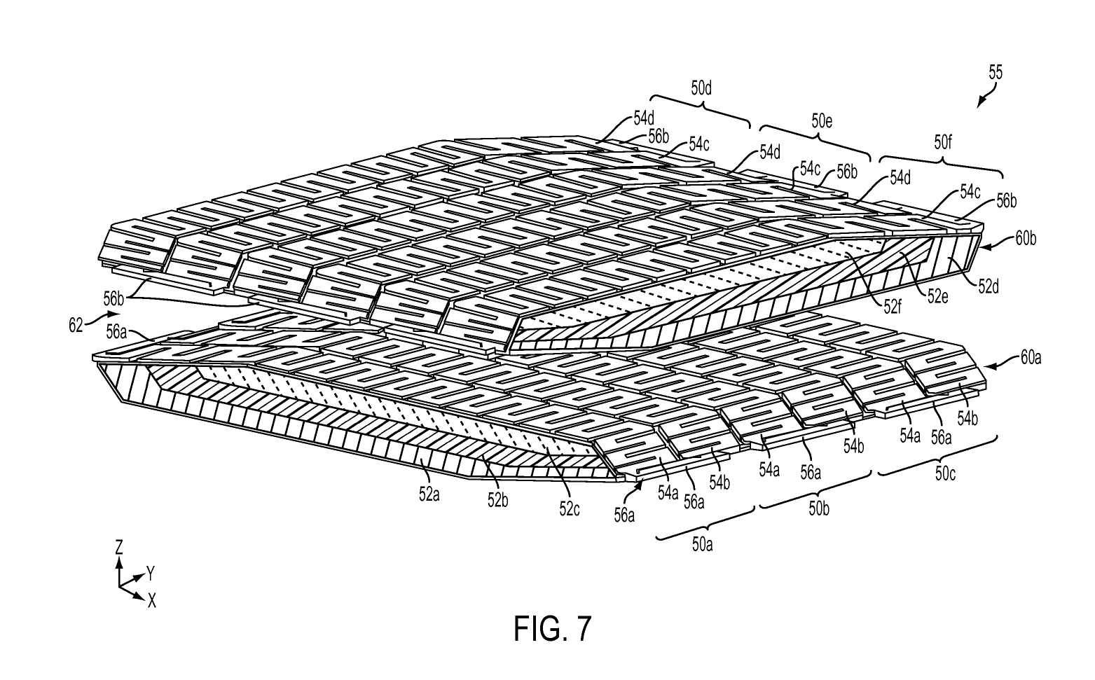

For motion in the x- and y-directions, FIG. 7 depicts a module 55 comprising three x-direction coil sets 50a, 50b, 50c and three y-direction coil sets 50d, 50e, 50f. Each coil set 50a, 50b, 50c has three respective hex coils 52a, 52b, 52c placed side-by-side, and each coil set 50d, 50e, 50f has three respective hex coils 52d, 52e, 52f placed side-by-side. The hex coils in the coil sets 50a, 50b, 50c are parallel to each other, as are the hex coils in the coil sets 50d, 50e, 50f, but the hex coils in the coil sets 50a, 50b, 50c are at right angles to the hex coils in the coil sets 50d, 50e, 50f. Thus, the x-direction coil sets 50a, 50b, 50c form an upper portion 60a, and the y-direction coil sets 50d, 50e, 50f form a lower portion 60b. Two respective cooling plates 54a, 54b cool each coil set 50a, 50b, 50c, and two respective cooling plates 54c, 54d cool each coil set 50d, 50e, 50f. The cooling plates 54a, 54b are hydraulically connected together by respective coolant manifolds 56a, and the cooling plates 54c, 54d are hydraulically connected together by respective coolant manifolds 56b. Although the upper portion 60a and lower portion 60b are shown in FIG. 7 as having a gap 62 therebetween, in an actual coil module 55 the two portions are placed together. Thus, the assembly 55 shown in FIG. 7 represents a 3×3 coil-set module.

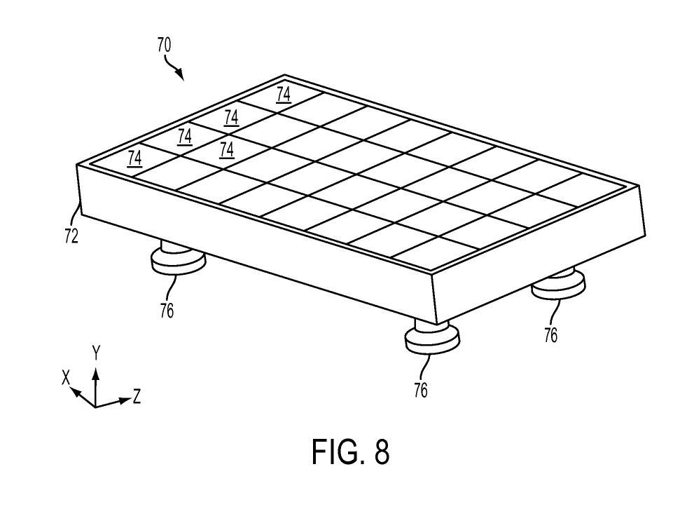

Turning now to FIG. 8, an exemplary array 70 of coil modules is shown. The array 70 extends in the x-y plane and is contained in a frame 72. Although a 4×8 array (4 modules in one direction and 8 modules in the other direction) is shown, an alternative array is a 9×12 array or a 6×7 array. If each module 74 is 144 mm×150 mm, then a 9×12 array has dimensions of 1.3 m×1.8 m. In certain embodiments, the array 70 can be a corresponding portion of a mass that serves, at least in part, as a counter-mass of the planar motor. For such use, the array 70 is mounted on air bearings 76 and is magnetically levitated to slide, in a substantially frictionless manner, in the x- and y-directions on a high-precision planar surface. In the array, any of the modules 74 can be removed and placed at any of the other module positions in the array. In FIG. 8, the modules 74 can comprise race-track coils or hex coils, for example, as discussed above.

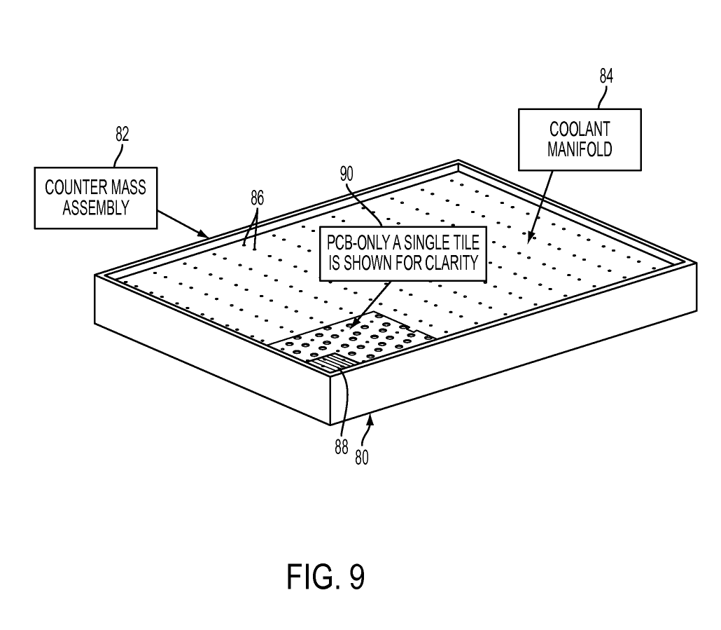

Referring to FIG. 9, a frame 80 is shown that constitutes a respective portion of a counter-mass assembly 82. The frame 80 contains a coolant manifold 84. The coolant manifold 84 defines a number of holes 86, arranged according to a particular pattern, to allow respective hydraulic connections to the inlet and outlet ports of modules 88 mounted to the coolant manifold. The frame 80 and coolant manifold 84 comprise the counter-mass assembly 82. In the figure, one module 88 is shown in the near corner, but it will be understood that normally the entire surface of the coolant manifold 84 is covered with modules 88. Between the modules 88 and the surface of the coolant manifold 88 is at least one printed circuit board (PCB) 90. The PCB 90 distributes power to the modules 100 and can also provide signal processing if the modules 100 include any respective sensors, for example. The PCB 90 desirably is sufficiently large to allow plural coil modules 88 to be attached to it, thereby minimizing interconnections. A PCB 90 with its constituent of modules 88 represents a higher-level modularity from single modules 88.

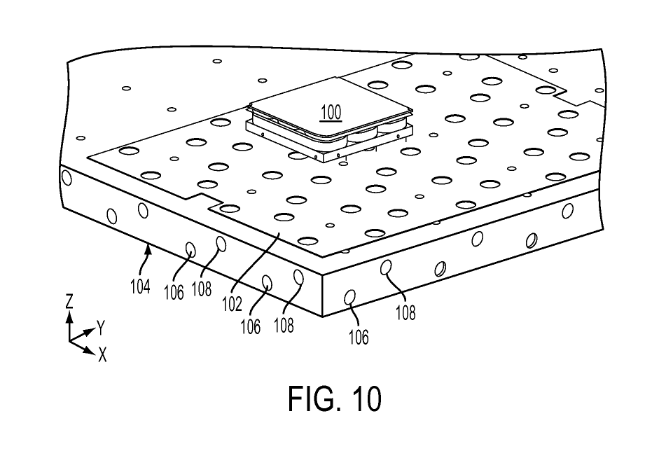

FIG. 10 is an “exploded” close-up of a race-track coil module 100 situated above its normal position on the PCB 102 on the surface of the coolant manifold 104. The PCB 102 is aligned with the coolant manifold 104 sufficiently for the inlet and outlet ports of the modules 100 to be connected through the PCB to the proper holes in the coolant manifold. Meanwhile, the coolant manifold 102 includes inlet ports 106 that supply fresh coolant to the modules 100, and outlet ports 108 that conduct spent coolant away. The modules 100 can be held to the surface of the coolant manifold 104 by any of various means, for example by bolts (not shown) extending upward from beneath the manifold.

The embodiments shown in FIGS. 9 and 10 are representative of coil arrays made of a matrix of coil modules (coil units) mounted on a relatively large coolant manifold.

The coolant manifold provides coolant delivery to the modules and coolant removal from the modules. More specifically, the coolant manifold delivers coolant to the various cooling plates in the coil module, including (if present) the STC plate.

To reduce pitching moments caused by offsets in the center of gravity (CG) between the stage and the stator (or counter-mass), the coolant manifold desirably is made of a high-density material such as stainless steel, brass, or tungsten. Generally, the closer the CG to the surface of the counter-mass, the smaller the pitching moment.

To handle the large number of electrical connections to the modules, several PCBs can be placed between the modules and the coolant manifold. The PCBs can handle many coil modules, as described above. The PCBs also simplify the assembly of the counter-mass and minimize the number of electrical interconnections requiring external wiring.

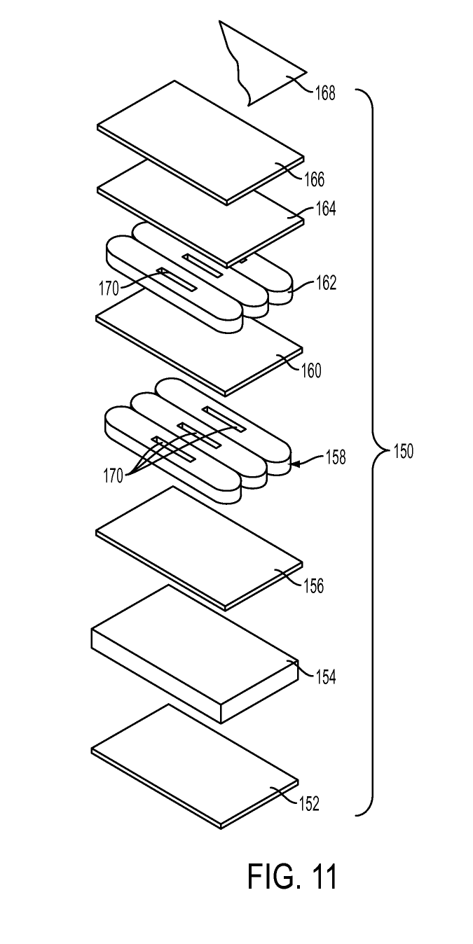

FIG. 11 is an isometric “exploded” view of yet another embodiment of a coil module 150 comprising multiple coils. The drawing is executed upside-down. This particular embodiment comprises six coils arranged as three pairs of two coils each. The coil module 150 is mountable to, for example, a countermass of a moving-coil type of planar motor. More specifically, the countermass includes a frame sized and configured to receive an array of multiple coil modules 150. The coil module 150 comprises a circuit board 152 that provides electrical power distribution, sensors, signal conditioning, and other electrical functions to and from the coil module 150. Mounted to the circuit board 152 is a manifold block 154 providing hydraulic connections and distribution of liquid coolant(s), both fresh and spent, throughout the coil module. Next are a first cooling plate 156 and first set of three coils 158, followed by a second cooling plate 160 and second set of three coils 162. Thus, the second cooling plate is an intermediate cooling plate with respect to the coils. In the figure, the coils 158, 162 are shown having the same orientation; such a coil module can be used to produce motor movement in one direction, such as the y direction. Alternatively, the coils 158, 162 can have respective orientations that are 90° apart to produce motor movement in two directions such as the x and y directions. Next are a third cooling plate 164 and STC plate 166.

If desired, a surface sheet 168 (e.g., a sheet of carbon fiber and epoxy) can be placed “atop” the STC plate. The surface sheet 168 provides a “fly surface” that opposes the surface of an array of fixed magnets during actual use. During operation of the motor, the coil assembly comprising the coil module is levitated relative to the surface of the magnet array, with a small gap being present between the fly surface and the surface of the magnet array. The carbon fibers in the surface sheet 168 are embedded in epoxy (desirably an epoxy having high thermal conductivity), which allows heat-transfer in-plane while reducing heat-transfer out of plane. Thus, the sheet 168 evens out “hot spots” to ±0.1° C. control.

The cooling plates 156, 160, 164, and STC plate 166 can have respective coolant passageways configured as simple channels, as “microchannels,” or both, depending at least in part on the cooling requirements of the coil module 150. The manifold block 154 supplies flow of coolant(s) to and from the plates 156, 160, 164, 166 with a minimal number of hydraulic connections and thus a minimal number of static hydraulic seals. To such end, the manifold block contains as much of the distributive hydraulic conduitry as possible, which also minimizes the number of hoses and the like that are connected to the coil module. It is also possible to incorporate the cooling plate 156 in the manifold block 154 so as further to reduce hydraulic interconnections and thus the number of hoses and static seals (such a combination is termed a “cold plate”).

As already noted, the manifold block 154 can be configured to supply one coolant or multiple coolants to the cooling plates and STC. Generally, supplying multiple coolants involves more complex conduitry, which can make fabrication of the manifold very difficult (especially machining certain conduits). One way in which to provide more complex conduitry is to fabricate the manifold block of multiple layers or portions each having respective drilled and machined voids destined to become, after assembling the portions together, respective conduits and passageways for respective coolant. The portions are bonded together (e.g., by brazing). In one example of a three-layer manifold block, a first layer can provide static seals for the coil modules and routing of a first coolant (e.g., water) thereto. A second layer can provide coolant transfer to individual zones, and a third layer can provide routing of a second coolant (e.g., Fluorinert).

In an analogous manner, the circuit board 152 desirably contains circuitry requiring a minimal amount of wiring to and from the circuit board.

In this embodiment, a respective manifold block 154 is included in each coil module 150. During assembly into an array of coil modules the manifold block can be connected to a larger manifold block or plate used for mounting and distributing coolant to multiple coil modules simultaneously. The midline of each coil 158 includes a mandrel 170 that can fulfill several functions. First, the mandrel 170 can serve to mount the respective coil to the coil module. Second, the mandrel 170 can be used to take up reactionary loads imposed on the coil module during use and couple such loads to the countermass. Third, the mandrel 170 can provide a route by which coolant is supplied to and/or from respective cooling plates.

In some embodiments it is desirable to minimize heat transfer from the manifold plate to the surface temperature control (STC) plate. This can be achieved by minimizing contact area between the STC plate and the manifold plate. The manifold plate is configured to remove a large amount of heat from the coil modules. The manifold plate also provides structural stiffness to the counter-mass to which the manifold plate is mounted. (The STC plate is also a structural component of the countermass.) Removing heat from the coil module will cause the temperature of the manifold plate to rise. The temperature of liquid circulating in the STC plate should be tightly controlled, but heat transfer from the coolant manifold plate should be avoided.

Using large-area air gaps between the coolant manifold and the STC, this heat transfer can be reduced. The region between these two hydraulic components can be used as shear connections, thereby increasing structural stiffness of the counter-mass. Air gaps can be provided in the range of 2 to 4 mm, for example.

As noted above, an array of coil modules can be configured as plug-in modules that are mounted to the countermass of the motor. The countermass includes at least one hydraulic manifold and at least one PCP. Mounting of the coil modules to the countermass can be achieved using bolts and any of various analogous mechanical fasteners. In other embodiments the coil modules themselves include any of various types of clips that provide each module with a “plug-in” capability without having to use extraneous fasteners. There are static seals (O-rings) at the interface of each coil module with the countermass to provide circulation of coolant into and out of each coil module mounted to the countermass. If desired or necessary, the countermass can be configured with multiple hydraulic manifolds to provide a first coolant to the microchannel plates and a second coolant to the STC plates. Electrical power and signals in and out of the coil units can be provided by a single connector connected to the manifold(s). In these embodiments, power and signal delivery from the countermass to the coil modules can be achieved using multiple PCB “mother boards” sandwiched between the coil modules and the countermass. A mother board can include on-board coil-driving electronics and/or signal-conditioning electronics for multiple coil units. The countermass can be divided into multiple “zones,” of which coolant flow is independently controlled. Multiple zones can provide more efficient coolant delivery. The coil units can further comprise respective STC plates, which can be cooled using a different coolant (Fluorinert) from the coolant (water) used for cooling coil microchannel plates. To provide adequate thermal control, the countermass desirably includes a coolant loop that is isolated from the active cooling system. This can be achieved by routing the Fluorinert to a separate countermass hydraulic manifold. This separate manifold desirably is placed below the manifold for routing coolant for the coil-cooling plates. Using hydraulic passageways that extend from one manifold to the next in, for example, a vertical direction, coolant from the water manifold is routed efficiently to the coil modules. This layered configuration can be made very compact.

In embodiments utilizing multiple hydraulic manifolds and coil units mounted to the countermass of the motor, it is desirable to minimize heat transfer from a first manifold to a second manifold, wherein the first manifold serves the STC plates and the second manifold serves the coolant plates associated with the coils. Minimizing heat transfer of this nature is achieved in some embodiments by minimizing contact area between the two manifolds. The second manifold is configured to remove a large amount of heat from the coil modules. The second manifold also provides structural stiffness to the countermass or other frame to which the second manifold is mounted. Removing heat from the coil modules will cause the temperature of the second manifold to increase. The temperature of coolant passing through the STC plates desirably is tightly controlled, and heat transfer from the second manifold to the first manifold desirably is avoided. (Note that the STC manifold is also a structural component of the countermass.) Heat transfer can be minimized by, for example, providing large-area air gaps between the first and second manifolds. The area connecting the two manifolds can be used to provide shear connections between the two manifolds, thereby increasing structural stiffness. For example, air gaps of 2 to 4 mm can be used.

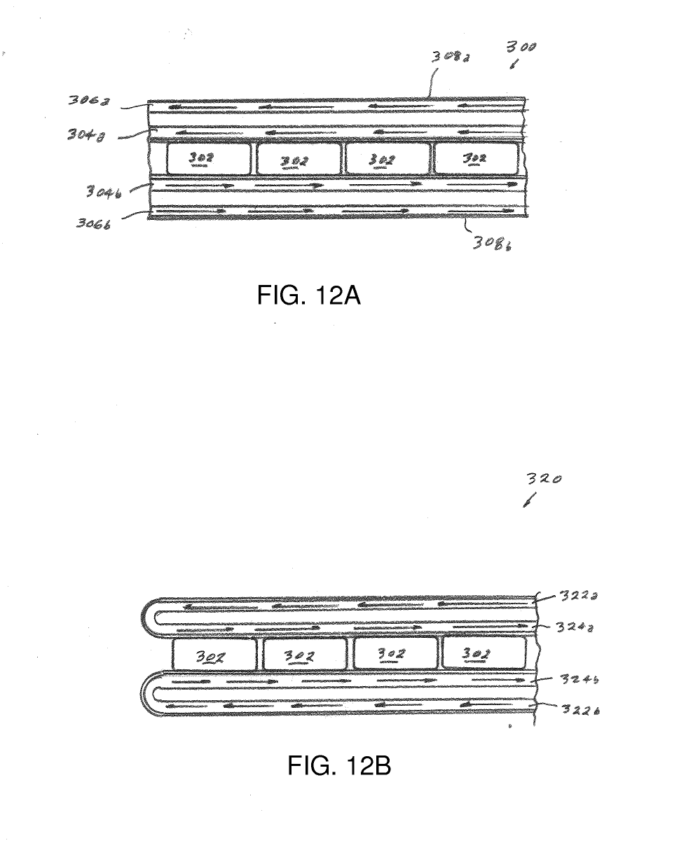

As a cooling plate absorbs heat, the temperature of the surface of the plate can exhibit a temperature rise. This temperature rise can adversely affect the performance of nearby components such as interferometers situated in the vicinity of the linear or planar motor. This temperature rise can be alleviated by configuring the cooling plate as a “double cold plate” comprising inner and outer portions, wherein the outer portion is configured to shield heat transfer from the “hot” surface of the inner portion. One embodiment 300 of a double cold plate is shown in FIG. 12A, in which are shown motor coils 302 flanked above and below by respective inner cold plates 304a, 304b. The inner cold plates 304a, 304b are, in turn, flanked above and below by respective outer cold plates 306a, 306b. Each cold plate includes a respective coolant channel. The channel can have any of various shapes and height dimensions, as required, ranging for example from a few millimeters to a few tens of micrometers. Hence, the channel can be a microchannel. The inner cold plates 304a, 304b are in contact with the coils 302 and are primarily used for removing heat from the coils. The outer cold plates 306a, 306b shield the “hot” surfaces of the respective inner cold plates 304a, 304b from ambient air. Flow of coolant (indicated by arrows) in the outer cold plates 306a, 306b maintains temperature uniformity on the outermost surfaces 308a, 308b of the structure.

In the configuration 300 shown in FIG. 12A, the inner cold plates 304a, 304b and outer cold plates 306a, 306b have separate supply and recovery of coolant without coolant recirculation between the cold plates. Coolant flow in the inner cold plates 304a, 304b and outer cold plates 306a, 306b can be in the same direction (parallel flow; as shown) or in opposite directions (counter-flow). Parallel flow is desirable for minimizing heat transfer from the inner cold plates 304a, 304b to the outer cold plates 306a, 306b. The outer cold plates 306a, 306b can be connected together to form a respective portion of the side wall of the motor, thus shielding the hot-side surfaces of the coils exposed from the ambient air.

It is also possible to recirculate coolant from an outer cold plate to an inner cold plate, as in the configuration 320 shown in FIG. 12B (depicting flow from the outer cold plates 322a, 322b to respective inner cold plates 324a, 324b. The coolant temperature does not rise significantly in the flow through the outer cold plates 322a, 322b. In an alternative configuration, coolant may be recirculated between the two outer cold plates 322a, 322b only (i.e., above and below the coils 302).

The geometry (height, shape, etc.) of the fluid passageways (channels) in the cold plates may be different between the outer and inner cold plates. For example, the channels in the outer cold plate may be configured to have laminar flow of coolant through them to provide low heat transfer and increased shielding effect, and the channels in the inner cold plate may be configured to have turbulent flow of coolant through them to maximize heat transfer from the coils to the coolant. A thermally insulating material or air gap may be present between the outer and inner cold plates to minimize heat transfer between them.

Although FIGS. 12A and 12B depict double cold plates as applied to a set of coils, it will be understood that the double cold-plate structure alternatively can be applied to each coil individually. Furthermore, although FIGS. 12A and 12B show coolant flow primarily along the length dimension of the motor, it will be understood that the cold plates can be configured such that coolant flow in the cold plates can be principally in another direction such as a direction that is perpendicular to that shown.

It is noted that, in some embodiments, the outer cold plates 306a, 306b are equivalent to the STC plate present in other embodiments described above.

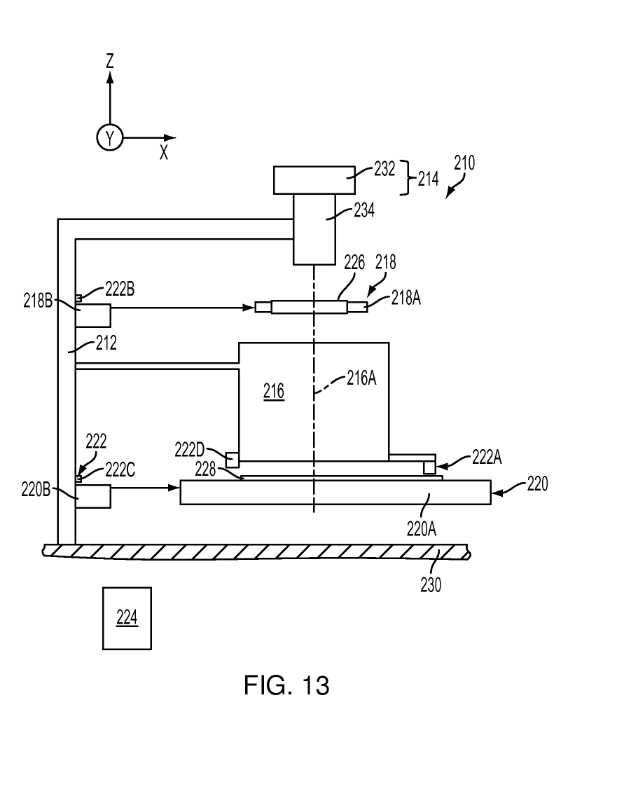

Included in this disclosure are any of various precision systems comprising a stage or the like that holds a workpiece or other item useful in a manufacture, relative to an axis, and that determines location of the stage at high accuracy and precision using devices and methods as described above. An example of a precision system is a microlithography system or exposure “tool” used for manufacturing semiconductor devices. A schematic depiction of an exemplary microlithography system 210, comprising features of the invention described herein, is provided in FIG. 13. The system 210 includes a system frame 212, an illumination system 214, an imaging-optical system 216, a reticle-stage assembly 218, a substrate-stage assembly 220, a positioning system 222, and a system-controller 224. The configuration of the components of the system 210 is particularly useful for transferring a pattern (not shown) of an integrated circuit from a reticle 226 onto a semiconductor wafer 228. The system 210 mounts to a mounting base 230, e.g., the ground, a base, or floor or other supporting structure. At least one of the stage assemblies 218, 220 includes a linear or planar motor comprising coil modules and at least one coil assembly as disclosed above.

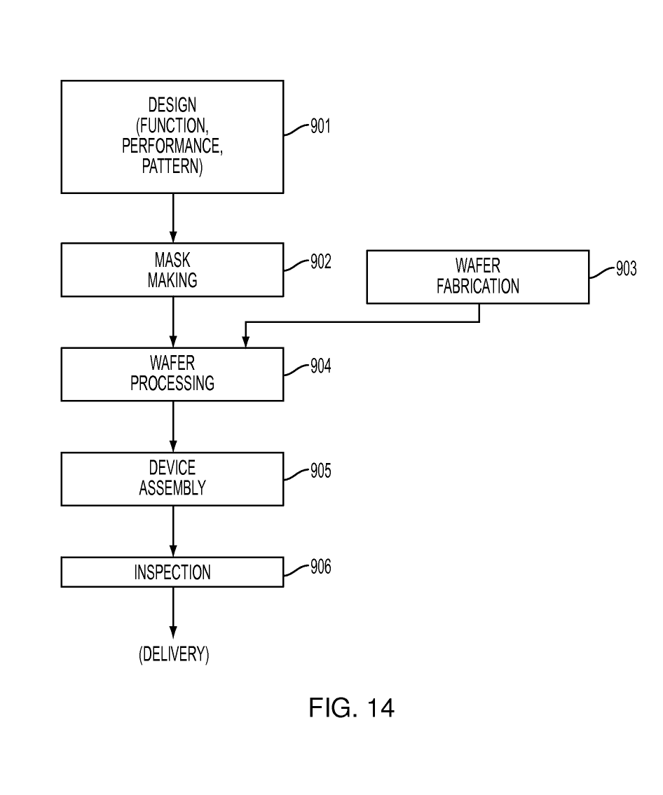

An exemplary process for manufacturing semiconductor devices, including an exposure step, is shown in FIG. 14. In step 901 the device's function and performance characteristics are designed. Next, in step 902, a mask (reticle) having a desired pattern is designed according to the previous designing step, and in a parallel step 903 a wafer is made from a suitable semiconductor material. The mask pattern designed in step 902 is exposed onto the wafer from step 903 in step 904 by a microlithography system described herein in accordance with the present invention. In step 905 the semiconductor device is assembled (including the dicing process, bonding process, and packaging process. Finally, the device is inspected in step 906.

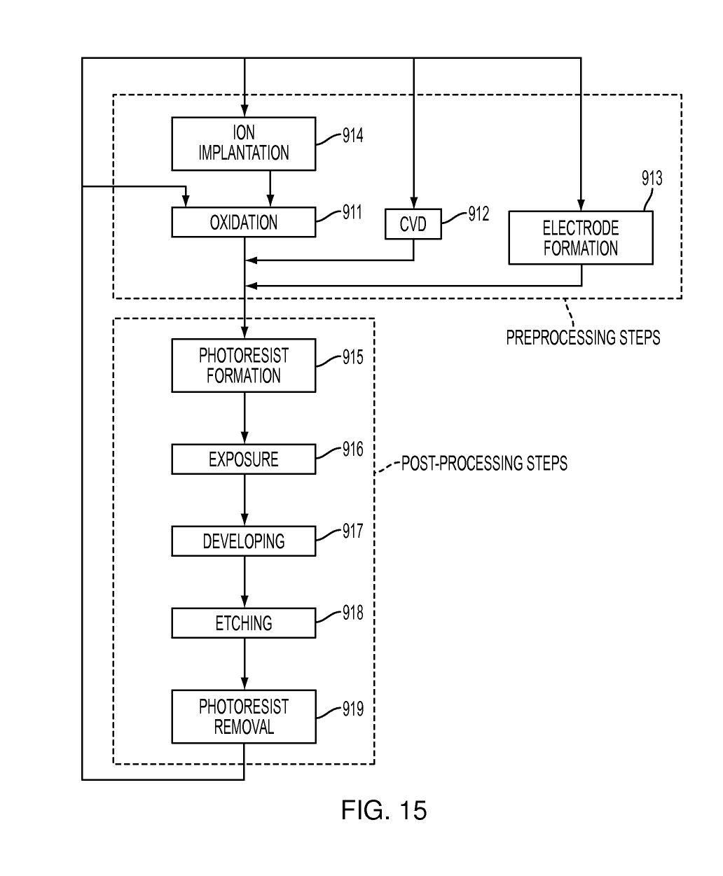

FIG. 15 is a flowchart of the above-mentioned step 904 in the case of fabricating semiconductor devices. In FIG. 15, in step 911(oxidation step), the wafer surface is oxidized. In step 912 (CVD step), an insulation film is formed on the wafer surface. In step 913 (electrode-formation step), electrodes are formed on the wafer by vapor deposition. In step 914 (ion-implantation step), ions are implanted in the wafer. The above-mentioned steps 911-914 constitute the preprocessing steps for wafers during wafer processing, and selection is made at each step according to processing requirements.

At each stage of wafer-processing, when the above-mentioned preprocessing steps have been completed, the following “post-processing” steps are implemented. During post-processing, first, in step 915 (photoresist-formation step), photoresist is applied to a wafer. Next, in step 916 (exposure step), the above-mentioned exposure device is used to transfer the circuit pattern of a mask (reticle) to a wafer. Then, in step 917 (developing step), the exposed wafer is developed, and in step 918 (etching step), parts other than residual photoresist (exposed material surface) are removed by etching. In step 919 (photoresist-removal step), unnecessary photoresist remaining after etching is removed. Multiple circuit patterns are formed by repetition of these pre-processing and post-processing steps.

The various embodiments disclosed herein render the subject apparatus modular and simple to assemble, use, and maintain. In addition, thermal management is substantially improved. Adequate cooling of the coils is achieved using minimal volume, and use of microchanneled cooling plates provides good control of surface temperature.

It will be understood that the principles disclosed above are not limited to planar-motor stators. The principles can be applied with equal facility to moving-coil movers on planar motors, and to any of various coil assemblies comprising multiple coils or coil sets. In addition, the principles can be applied to planar-motor stators and movers, and to members (e.g., planar-motor counter-masses) including such stators, as used on precision equipment. Such equipment includes, but is not limited to, precision systems for moving and placing a workpiece relative to a process tool. An exemplary precision system is a microlithography system, in which the subject stators, planar-motors, and counter-masses are associated with one or more stages in such systems.

What is claimed is:

1. A coil array for a planar or linear motor, the coil array comprising multiple coil modules, each coil module comprising at least one coil set, respective electrical circuitry to and from the coil set, at least one respective hydraulic cooling device for the coil set, and respective hydraulic conduitry to and from the cooling device, the coil modules being interchangeably mountable relative to each other in the array such that mounting the coil module to the array produces accompanying hydraulic and electrical connections between the array and coil module and removing the coil module from the array severs the connections.

2. The coil array of claim 1, wherein in each coil module:
the coil set comprises multiple coils; and
the hydraulic cooling device comprises multiple cooling plates placed individually above, below, and/or between the coils of the coil set.

3. The coil array of claim 2, wherein at least one of the cooling plates is a microchanneled cooling plate.

4. The coil array of claim 2, wherein:
the cooling plate situated above the coils is a top cooling plate; and
the coil modules further comprise respective STC plates situated above the top cooling plate.

5. The coil array of claim 1, further comprising an hydraulic manifold configured to receive multiple coil modules of the array while also making respective hydraulic connections to the coil modules mounted to the manifold plate.

6. The coil array of claim 1, wherein the coil modules further comprise respective manifold blocks connected hydraulically to the cooling device and that is connectable interchangeably to a manifold defining hydraulic conduitry distributing flow of a coolant to multiple coil modules mounted relative to the manifold.

7. The coil array of claim 1, further comprising a circuit board and coolant manifold, the circuit board and manifold constituting a base to which multiple coil modules of the array are mounted interchangeably while making respective electrical connections to and from the modules and circuit board and respective hydraulic connections to and from the modules and the coolant manifold.

8. The coil array of claim 1, wherein:
the manifold comprises first and second manifold portions;
the coil modules further comprise respective top cooling plates and respective STC plate situated above the top cooling plate;
the STC plates are configured to receive circulation of a first coolant delivered to the STC plates from the first manifold portion; and
the cooling plates are configured to receive circulation of a second coolant delivered to the cooling plates from the second manifold portion.

9. The coil array of claim 8, wherein the first and second manifold portions are thermally insulated from each other.

10. The coil array of claim 1, comprising at least a first zone and a second zone each receiving a respective group of coil modules, wherein the coil modules of the first zone are thermally controlled differently from the coil modules of the second zone.

11. The coil array of claim 1, wherein at least one coil module of the array comprises a cooling device having a double cold plate configuration.

12. A coil module, comprising:
at least one coil set; and
at least one hydraulic cooling device situated relative to the coil set to draw heat from the coil set, the coil module being interchangeably connectable electrically and hydraulically as a module to a base and arranged on the base relative to at least one other such coil module to form an array of multiple coil modules of a linear or planar motor.

13. The coil module of claim 12, wherein:
the coil set comprises multiple coils; and
the hydraulic cooling device comprises multiple cooling plates placed individually above, below, and/or between the coils of the set.

14. The coil module of claim 13, wherein at least one of the cooling plates is a microchanneled cooling plate.

15. The coil module of claim 13, wherein at least one of the cooling plates has a double cold plate configuration.

16. The coil module of claim 13, wherein:
the cooling plate situated above the coils is a top cooling plate; and
the coil modules further comprise respective STC plates situated above respective top cooling plates.

17. The coil module of claim 12, further comprising at least one circuit board electrically connected to the at least one coil set, the at least one circuit board comprising electronic circuitry controlling the at least one coil set.

18. The coil module of claim 12, further comprising a coolant manifold plate connected hydraulically to the cooling device and that is connectable interchangeably to a multi-unit manifold defining hydraulic conduitry distributing flow of a coolant to multiple coil modules mounted thereto.

19. A coil array for a linear or planar motor, comprising multiple coil-set modules mounted to respective mounting locations on a base, the coil-set modules comprising respective electrical coil sets and respective hydraulic conduits conducting liquid coolant relative to the coil sets to cool the coil sets, and the modules being interchangeable with each other on the base.

20. The coil array of claim 19, wherein the base comprises a manifold comprising at least one coolant-inlet conduit and at least one coolant-outlet conduit, the inlet and outlet conduits being connectable to the respective conduits on the modules as the modules are mounted to the manifold plate, and disconnectable from the respective conduits on the modules as the modules are removed from the manifold plate.

21. The coil array of claim 20, wherein the manifold plate provides hydraulic inlet and outlet connections for coolant for the modules mounted thereto.

22. The coil array of claim 20, wherein the base further comprises at least one printed circuit board located relative to respective modules to provide electrical connections to the coils of the respective modules as the modules are mounted to the base.

23. The coil array of claim 20, comprising multiple circuit boards associated with respective regions of the base and to which respective multiple modules are connected.

24. The coil array of claim 19, further comprising at least one printed circuit board located relative to respective modules to provide electrical connections to the coils of the respective modules as the modules are mounted to the base.

25. The coil array of claim 19, configured as a stator for a moving-magnet planar motor.

26. The coil array of claim 19, configured as a mover for a moving-coil planar motor.

27. The coil array of claim 19, wherein the base is a respective portion of a counter-mass of the linear or planar motor.

28. The coil array of claim 19, wherein the mounting locations are arrayed as a regular matrix on the base.

29. The coil array of claim 19, wherein the coil sets of the modules further comprise respective first coil sets oriented in a first x-y direction, and respective second coil sets oriented in a second x-y direction.

30. The coil array of claim 29, wherein the at least one conduit in the modules comprises a first microchanneled cooling plate associated with the first coil set and a second microchanneled cooling plate associated with the second coil set in the modules.

31. The coil array of claim 30, wherein the at least one conduit in the modules further comprises a third microchanneled cooling plate situated between the coil sets in the modules.

32. The coil array of claim 31, wherein the modules further comprise respective surface-temperature control microchanneled plates.

33. The coil array of claim 31, wherein:
the base comprises a manifold plate providing hydraulic inlet and outlet connections for coolant for the modules mounted thereto; and
the first, second, and third microchanneled plates comprise respective inlets and outlets connected to the hydraulic inlet and outlet connections on the manifold plate as the modules are attached to the manifold plate.

34. The coil array of claim 33, wherein:
the modules further comprise respective surface-temperature control microchanneled plates including respective inlet and outlet connections; and
the inlet and outlet connections of the surface-temperature control microchanneled plates connect to the respective hydraulic inlet and outlet connections on the manifold plate as the modules are attached to the manifold plate.

35. The coil array of claim 19, wherein:
the base is configured as a manifold plate comprising at least one coolant-inlet conduit and at least one coolant-outlet conduit for each module, the inlet and outlet conduits being connectable to the respective inlet and outlet conduits on the modules as the modules are mounted to the manifold plate, and disconnectable from the respective conduits on the modules as the modules are removed from the manifold plate; and
the modules comprise respective first coil sets and respective second coil sets, respective first coolant microchanneled plates associated with the first coil sets, respective second coolant microchanneled plates associated with the second coil sets, and respective surface temperature control microchanneled plate, the microchanneled plates having inlets and outlets in the module that connect to the inlet conduit and outlet conduit, respectively, of the manifold plate as the module is mounted to the manifold plate and that disconnect from the inlet conduit and outlet conduit, respectively of the manifold plate as the module is being removed from the manifold plate.

36. A linear or planar motor, comprising a coil array as recited in claim 1.

37. A linear or planar motor, comprising a coil module as recited in claim 12.

38. A linear or planar motor, comprising a coil array as recited in claim 19.

39. A stage, comprising a moving member and a linear or planar motor, as recited in claim 36, that moves and positions the moving member.

40. A stage, comprising a moving member and a linear or planar motor, as recited in claim 37, that moves and positions the moving member.

41. A stage, comprising a moving member and a linear or planar motor, as recited in claim 38, that moves and positions the moving member.

42. A precision system, comprising a stage as recited in claim 39.

43. A precision system, comprising a stage as recited in claim 40.

44. A precision system, comprising a stage as recited in claim 39.

45. The precision system of claim 42, configured as a microlithography system.

46. The precision system of claim 43, configured as a microlithography system.

47. The precision system of claim 44, configured as a microlithography system.
